(19) United States
(12) Patent Application Publication
(10) Pub. No.: US 2005/0107279 A1
(43) Pub. Date: May 19, 2005

(54) Emulsion composition

(75) Inventors: Malvinder Ahluwalia, Bangalore (IN); Gautam Chandrakanth Kini, Bangalore (IN); Pattath Rejitha, Bangalore (IN); Deeleep Kumar Rout, Bangalore (IN)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 10/967,464

(22) Filed: Oct. 18, 2004

(30) Foreign Application Priority Data
Oct. 20, 2003 (IN) 1104/MUM/03
Dec. 2, 2003 (EP) 03078791.5

(51) Int. Cl. C11D 17/00

(52) U.S. Cl. 510/407

(57) ABSTRACT

The present invention provides a novel cleaning composition in the form of a microemulsion, comprising (a) 5-95% by weight a surfactant with a HLB greater than 8, (b) 0.1-95% by weight of one or more hydrophobic liquids having a net log p value greater than 3.0 and a water solubility less than 0.1%, and (c) 0.05-95% by weight water. Superior cleaning of both oily and particulate soil could be obtained when using a microemulsion of the present invention.

### TECHNICAL FIELD

The present invention relates to a microemulsion that forms a spontaneous dispersion of hydrophobic liquid in water. It is suited for cleaning fabric and hard surfaces and also in personal cleansing.

### BACKGROUND AND PRIOR ART

Cleaning of soiled fabric and other substrates has been an important area of concern and there have been several approaches to solve the problem. Several compositions in various product forms have been formulated to enhance the soil removal from substrates and achieve efficient cleaning.

Microemulsions have been used to achieve soil removal in a variety of cleaning applications. It is possible to dilute these with water to form a wash solution. Microemulsion cleaning technology has proved useful as a vehicle for delivering typically surfactant blends to a cleaning location to a large extent. However, typical microemulsion compositions do not provide desired soil removal when challenged with cleaning of tough soils and mixtures of oily and particulate soils. The tough soils in particular are carbonaceous particulates in combination with hydrophobic oily soil. Microemulsions have also been formulated for cleaning hard surfaces.

The removal of oily soils and stains from fabrics has been the focus in fabric cleaning and emphasis has been placed on pre-treating or pre-spotting compositions for cleaning shirt collars and cuffs, as a preliminary stain-removal treatment prior to regular washing.

Efficient cleaning of surfaces especially in hand wash situations remains an issue and improvements in formulations have been desired.

WO-A-92/20773 describes a cleaning composition in the form of an oil-absorbent microemulsion comprising a surfactant capable of absorbing an oil by spontaneous emulsification. The mechanism of spontaneous emulsification is claimed to be more efficient than the roll-up mechanism by which most conventional cleaning compositions remove soil. Also, it has to be used as an adjunct with a commercial detergent to show benefits over other commercial pre-spotters. It is not shown to be a main wash formulation/pre-spotter in the absence of commercial detergents.

EP-A-316726 discloses a stable, clear, microemulsion for cleaning surfaces with oily or greasy soils comprising a synthetic organic detergent, water and co-surfactant. These are mainly employed for cleaning tiles, floors as a spray-and-wipe type of formulation. If the composition is formulated with an acidic pH then it is useful for removing lime scale deposits.

It has been possible to develop a superior fabric cleaning formulation in the form of a microemulsion that forms a spontaneous, kinetically stable dispersion of hydrophobic liquids in water.

### OBJECTS OF THE INVENTION

It is an object of the present invention to obtain a superior cleaning of fabric and hard surfaces by formulating a microemulsion that forms a spontaneous, kinetically stable dispersion of hydrophobic liquid in water.

It is another object of the present invention to obtain a superior cleaning in both hard or soft water as well as saline water even in the absence of the builders, by formulating a microemulsion that forms a spontaneous, kinetically stable dispersion of hydrophobic liquid in water.

It is another object of the present invention to obtain a superior cleaning of both oily as well as particulate soil and especially tough soil deposited on the collar and cuffs of fabric, and other difficult to clean soils for e.g. lipstick, shoe polish, motor oil, by formulating a microemulsion that forms a spontaneous, kinetically stable dispersion of hydrophobic liquid in water.

It is another object of the present invention to obtain a superior cleansing in personal wash by formulating a microemulsion that forms a spontaneous, kinetically stable dispersion of hydrophobic liquid in water.

It is another object of the present invention to deliver benefit agents and obtain a superior cleaning by formulating a microemulsion that forms a spontaneous, kinetically stable dispersion of hydrophobic liquid in water.

### SUMMARY OF THE INVENTION

According to the present invention there is provided a novel cleaning composition in the form of a microemulsion comprising:
i. 5-95% by weight a surfactant with a HLB greater than 8
ii. 0.1-95% by weight of one or more hydrophobic liquids having a net log p value greater than 3.0 and a water solubility less than 0.1%
iii. 0.05-95% by weight water
iv. 0-35% by weight of a salting out electrolyte

According to a preferred aspect of the present invention there is provided a novel cleaning composition in the form of a microemulsion comprising:
i. 5-95% by weight a surfactant with a HLB greater than 8
ii. 0.1-95% by weight of one or more hydrophobic liquids having a net log p value greater than 3.0 and a water solubility less than 0.1% wherein at least 5% of a hydrophobic liquid has a log p value less than 4.3 and a water solubility less than 0.1%
iii. 0.05-95% by weight water
iv. 0-35% by weight of a salting out electrolyte.

According to another aspect of the invention, there is provided a method of cleaning soiled substrate, comprising the steps of (a) cleaning the substrate with a composition of the invention and (b) rinsing the substrate. Desirably, the substrate is a fabric substrate. Preferably, the substrate is brought into contact with a solution prepared by diluting the composition of the invention in soft, hard or saline water.

### DETAILED DESCRIPTION OF THE INVENTION

The term ‘microemulsion’ is now fairly well defined and a further review on the subject is given in Strey, R. “Phase Behaviour and Interfacial curvature in water-oil-surfactant systems”, Current Opinion in Colloid and Interface Science 1996, 1: 402-410. The term microemulsion as per this invention also includes the surfactant/hydrophobic liquid blends at the balanced plane of the phase prism. Further details of the balanced plane are given in Xingfu Li, Koichi Ueda, Hironobu Kunieda, “Solubilization and Phase Behaviour of Microemulsions with Mixed Anionic-Cationic Surfactants and Hexanol”, Langmuir 1999, 15, 7973-7979.

The microemulsion compositions of the present invention may be used as a pre-spotter or in bulk washing with lots of water. The interfacial tension of the hydrophobic liquid-water interface in the spontaneous dispersion of hydrophobic liquid in water would preferably be in the range of 0.01 to 5 mN/m.

Surfactant

The surfactant may be chosen from anionic, nonionic, cationic, amphoteric or zwitterionic to be incorporated in the formulation but the HLB of the surfactant is greater than 8.0.

The anionic surfactants for the invention may have an alkali or alkaline earth metal or ammonium, hydroxy alkyl ammonium or alkanolamine counter ion of or a mixture thereof. Suitable anionic detergent active compounds are water soluble salts of organic sulphuric reaction products having in the molecular structure an alkyl radical containing from 8 to 22 carbon atoms, and a radical chosen from sulphonic acid or sulphuric acid ester radicals and mixtures thereof. They may also be selected from carboxylates, phosphates, sulphosuccinates or succinate derivatives.

Examples of suitable anionic surfactants are sodium and potassium alcohol sulphates, especially those obtained by sulphating the higher alcohols produced by reducing the glycerides of tallow or coconut oil; sodium and potassium alkyl benzene sulphonates such as those in which the alkyl group contains from 9 to 15 carbon atoms; sodium alkyl glyceryl ether sulphates, especially those ethers of the higher alcohols derived from tallow and coconut oil; sodium coconut oil fatty acid monoglyceride sulphates; sodium and potassium salts of sulphuric acid esters of the reaction product of one mole of a higher fatty alcohol and from 1 to 6 moles of ethylene oxide; sodium and potassium salts of alkyl phenol ethylene oxide ether sulphate with from 1 to 8 units of ethylene oxide molecule and in which the alkyl radicals contain from 4 to 14 carbon atoms; the reaction product of fatty acids esterified with isethionic acid and neutralised with sodium hydroxide where, for example, the fatty acids are derived from coconut oil and mixtures thereof.

A specific type of anionic surfactant that may also be used in the compositions according to the invention is the group of fatty acid soaps. The term soap denotes salts of carboxylic fatty acids. The soap may be derived from any of the triglycerides conventionally used in soap manufacture—consequently the carboxylate anions in the soap may contain from 8 to 22 carbon atoms. The soap may be obtained by saponifying a triglyceride and/or a fatty acid. The triglyceride may be fats or oils generally used in soap manufacture such as tallow, tallow stearines, palm oil, palm stearines, soya bean oil, fish oil, caster oil, rice bran oil, sunflower oil, coconut oil, babassu oil, palm kernel oil, and others.

In the above process the fatty acids are derived from oils/fats selected from coconut, rice bran, groundnut, tallow, palm, palm kernel, cotton seed, soybean, castor etc.

The preferred anionic surfactants include sodium, potassium, calcium, barium, magnesium, ammonium and hydroxy alkyl ammonium sulfates, sulfonates, carboxylates, phosphates, sulfosuccinates, succinate derivatives, fatty acid soaps, alkyl benzene sulfonates (sodium salt), alpha olefin sulfonates, alcohol sulfates, and ethoxylated alcohol sulfates.

Suitable non-ionic surfactants that can be broadly described as compounds produced by the condensation of alkylene oxide groups, which are hydrophilic in nature, with an organic hydrophobic compound which may be aliphatic or alkyl aromatic in nature. The length of the hydrophilic or polyoxyalkylene radical which is condensed with any particular hydrophobic group can be readily adjusted to yield a water-soluble compound having the desired degree of balance between hydrophilic and hydrophobic elements. Other nonionic surfactants that can be employed include the alkylpolyglucosides. The preferred list of non-ionic surfactants include alcohol ethoxylate, alkyl phenol ethoxylate, polyoxyethylene esters of fatty acids, polyoxyethylene fatty acid amides, alkyl polysaccharides, ethoxylates of alkyl amine, castor oil, end capped synthetic alcohol, tallow amine, alkanol amine mercaptan.

Suitable cationic surfactants that can be incorporated are alkyl substituted quarternary ammonium halide salts e.g. bis (hydrogenated tallow) dimethylammonium chlorides, cetyltrimethyl ammonium bromide, benzalkonium chlorides and dodecylmethylpolyoxy ethylene ammonium chloride and amine and imidazoline salts for e.g. primary, secondary and tertiary amine hydrochlorides and imidazoline hydrochlorides. The preferred list of cationic surfactants include dodecyl dimethyl ammonium chloride, alkyl dimethyl amines and alkyl amidopropyl amines, quarternised amine ethoxylates.

Suitable amphoteric surfactants that optionally may be employed are derivatives of aliphatic secondary and tertiary amines containing an alkyl group of 8 to 18 carbon atoms and an aliphatic radical substituted by an anionic water-solubilizing group, for instance sodium 3-dodecylamino-propionate, sodium 3-dodecylaminopropane sulphonate and sodium N-2-hydroxydodecyl-N-methyltaurate. The preferred amphoteric surfactants are alkyl dimethyl betaines.

The surfactants used in the detergent composition of the invention could also be chosen from the detergent active compounds given in the well-known textbooks “Surface Active Agents”, Volume I by Schwartz and Perry and “Surface Active Agents and Detergents”, Volume II by Schwartz, Perry and Berch.

It is also possible to formulate mixed surfactants by choosing them from any of the above mentioned while ensuring that the blend has a HLB>8.0.

Hydrophobic Liquid

Log P is a property defined in the article Hiroshi Chuman, Atsushi Mori and Hideji Tanaka, “Prediction of the 1-Octanol/H₂O Partition Coefficient, Log P, by Ab Initio MO Calculations: Hydrogen-Bonding Effect of Organic Solutes on Log P”, Analytical Sciences, September 2002, Vol. 18, 1015-1020. Log P is basically the 1-octanol/water partition coefficient and is experimentally determined by the shake-flask method.

Hydrophobic liquids with net log p greater 3.0, so long as the % solubility in water is less than 0.1%, are suitable for employing in the formulation. It is particularly preferred that at least 5% of the hydrophobic liquids is a liquid which has a log p value less than 4.3, having a % solubility in water less than 0.1%. The water solubility of the hydrophobic liquid is preferably less than 0.01% and more preferably less than 0.001%. The hydrophobic liquids having a log p value greater than 3.0 and water solubility less than 0.1% include hydrocarbons, e.g. octanes, nonane, decane, dodecane, hexadecane, paraffin oil; alcohols, e.g. dodecanol, oleyl alcohol; acids, e.g. leic acid; aldehydes, e.g. dodecanal, hexadecanal; ketones, e.g. methyl nonyl ketone; esters, e.g. methyl stearate, eicosanoic acid methyl ester, palm fatty acid ester; ethers, e.g. di iso pentyl ether, dihexyl ether, diheptyl ether, dioctyl ether, didecyl ether.

The hydrophobic liquids having a log p value less than 4.3 and a water solubility less then 0.1% include acids, e.g. caproic acid, caprylic acid, capric acid; alcohols, e.g. octanol, decanol; aldehydes, e.g. octanal, decanal; esters, e.g. hexyl acetate.

The preferred weight percent of hydrophobic liquid in the final wash liquor obtained after diluting a composition of the invention with water, is from 0.01 to 1.5, more preferably in the range of 0.2 to 1.0 and most preferably in the range of 0.3 to 0.7.

Salting Out Electrolytes

The salting out electrolytes as per this invention include alkali and alkaline earth metal salts (preferably of sodium, potassium, barium, calcium, magnesium) e.g halides, hypochlorite, perchlorite, bicarbonate, carbonate, bisulphite, sulphite, sulphonate, nitrate, phosphates, polyphosphates, acetate, citrate, succinate; ammonium salts of halides, hypochlorite, perchlorite, bicarbonate, carbonate, bisulphite, sulphite, sulphonate, nitrate, phosphates, polyphosphates, acetate, citrate, succinate; EDTA and quarternary ammonium salts.

The salting out electrolyte as per this invention is preferably added at a level of 0.5% to 30%, more preferably 0.5 to 15%, even more preferably at 0.5-6%, and most preferably from 0.5 to 2% by weight.

Product Form

The microemulsion is preferably a liquid formulation but the microemulsion can also be loaded on to solid supports to obtain solid formulations like a powder, bar, cake, tablet formulations or semisolid formulations such as gels, pastes, slurries etc. It is also possible to provide certain solid or liquid detergency enhancers along with the microemulsion in the form of a kit.

Preferably, the microemulsion of the invention is free of builders.

Benefit Agents

Other conventional benefit agents that are incorporated in detergent compositions such as bleaches, fluorescers, perfumes, polymers, enzymes, sunscreens/anti-yellowing agents, anti-microbial agents, fabric softeners/conditioners, whiteness maintenance agents, oil soluble/surface active dyes, indicators may form part of the microemulsion of the present invention.

### EXAMPLES

The invention will be further described by the following illustrative non-limiting examples.

Detergency Results by Washing in the “Bulk Wash Mode”:

The “bulk wash mode” refers to a method of washing fabrics which simulates the washing carried out in a bucket. The formulations as listed in Tables 1 and 2 (Ex-1 to 10) were added to water/brine to form a wash liquor at an active (surfactant) concentration at 1.5 grams/liter.

The test monitors, both cotton and polycotton (WFK 10D and WFK 20D) were added to the wash liquor at a liquor to cloth (L/C) ratio of 25:1. Nine balls per pot were added. The pots were stirred with an oscillation frequency of 45 rpm. The soak time was maintained at 30 minutes and the wash time at 30 minutes at 28° C. The cloth after washing was rinsed in soft water at L/C ratio of 40:1. The swatches were dried using a maxi drier. The fabric reflectance (initial/final) measurements were made using a Color-Eye Macbeth Reflectometer, (using UV Excluded, Specular Included and Large Aperture View mode) and difference in reflectance dR(460*) was calculated.

5 swatches (cloth test monitors) each of fabric types WFK 10D and WFK 20D were taken together in each pot per experiment for determining statistical significance. All experiments of detergency have been repeated at least 2 times for reproducibility checks.

The number of balls (9) per pot is based on the standardized Launder-O meter protocol. The balls serve as a means of agitation that simulates agitation in hand wash situation.

TABLE 1

| Components | | | | | | | |
|---|---|---|---|---|---|---|---|
| % wt. | Ex. 1 | Ex. 2 | Ex. 3 | Ex. 4 | Ex. 5 | Ex. 6 | Ex. 7 |
| Surfactant | C₁₂EO₇:C₁₂EO₃ | C₁₂EO₇:C₁₂EO₃ | C₁₂EO₇:C₁₂EO₃ | C₁₂EO₇:C₁₂EO₃ | C₁₂EO₃ | C₁₂EO₃ | C₁₂EO₃ |
| | 9:1 | 9:1 | 9:1 | 9:1 | | | |
| Surfactant HLB | 11.6 | 11.6 | 11.6 | 11.6 | 8 | 8 | 8 |
| Surfactant wt %. | 90 | 21.6 | 15.8 | 17.0 | 25.0 | 25.0 | 24.8 |
| in formulation | | | | | | | |
| Hydrophobic | 9 | 34.2 | 36.8 | 37.3 | 37.5 | 36.5 | 36.3 |
| Liquid LLPO, wt % | | | | | | | |
| (Log P = 10 and | | | | | | | |
| solubility = 10⁻⁹%) | | | | | | | |
| Second Hydrophobic | — | — | 1.9 | 4.2 | — | 1.0 | 1.0 |
| Liquid, , wt % | | | | | | | |
| Caprylic acid, | | | | | | | |
| (Log P = 3.03 | | | | | | | |
| and solubility = 6 × 10⁻³%) | | | | | | | |
| Water, wt % | 1.0 | 34.2 | 38.7 | 41.5 | 37.5 | 37.5 | 37.2 |
| Salt (sodium | — | 10.0 | 6.8 | — | — | — | 0.7 |
| Chloride), wt % | | | | | | | |
| Nature of | Single | Single | Single | Single | Single | Single | Single |
| Formulation | phase | phase | Phase | Phase | Phase | Phase | phase |
| Initial wash | water | 22.5% | 15% | 0.5% | water | water | 1.8% |
| solution | | brine | brine | brine | | | brine |
| Nature of wash | Clear | Clear | Clear | Clear | Turbid | Turbid | Turbid |
| Liquor emulsion | and | and | and | and | | | |
| | kinetically | kinetically | kinetically | kinetically | | | |
| | stable | stable | stable | stable | | | |
| dR(460*), | 14 | 20 | 20 | 21 | 0.7 | −1.5 | 2.5 |
| WFK10D | | | | | | | |
| dR(460*), | 16 | 28 | 27 | 26 | −2.9 | −3.6 | −0.4 |
| WFK20D | | | | | | | |

LLPO refers to light liquid paraffin oil

TABLE 2

| Components % wt. | Ex. 8 | Ex. 9 | Ex. 10 |
|---|---|---|---|
| Surfactant C₁₂EO₇; HLB = 12 | 25 | 25 | 24.8 |
| Hydrophobic Liquid, (Hexanol); | 37.5 | 36.5 | 36.3 |
| wt % Log P = (2.03); | | | |
| solubility in water = 0.6% | | | |
| Second Hydrophobic Liquid | — | 1.0 | 1.0 |
| Caprylic acid, | | | |
| wt % (Log P = 3.03 and | | | |
| solubility = 6 × 10⁻⁶%) | | | |
| Water | 37.5 | 37.5 | 37.2 |
| Salt (sodium Chloride), wt % | — | — | 0.7 |
| Nature of formulation | Two phase | Two phase | Two phase |
| Nature of wash Liquor emulsion | Turbid | Turbid | Turbid |

The data in Table-1 indicate that formulation as per the basic aspect of the invention (Ex-1) is single phase and is clear; the wash liquor when diluted with water is a clear and kinetically stable wash emulsion. The test monitors when washed in this liquor as per the procedure given above gives excellent cleaning. The formulations as per more preferred aspects of the invention (Ex-2 to 4) with added second hydrophobic liquid and/or an salting-out electrolyte also give excellent cleaning.

Data in Table-1 and Table-2 also provide the examples outside the invention (Ex 5 to 10) which show that either the formulation phase separates, the wash liquor is turbid or the cleaning is poor.

Detergency Results by Washing in the “Direct Application Mode” Over Various Controls.

The direct application mode refers to a pre-spotter type of proposition to clean tough oily stains, where the composition is applied locally at the stain area and is diluted with water for washing.

The formulations listed in Table-3 were applied directly on the fabric(s). After 2 minutes, the region on which the formulation was applied is diluted with water and is transferred to the LaunderO pot where the protocol as described below are followed. The dosage of the formulation is such that the end active (surfactant) level in the wash solution is 1.5 grams/litre. The test monitor used was poly-cotton (WFK20D). For Ex-11, the test monitor was transferred to a lgram/litre sodium carbonate solution instead of water.

The Liquor to cloth (L/C) ratio was maintained at 25:1 using 0 FH deionized water. Nineballs per pot were added. The detergency was carried out at an oscillation frequency of 45 rpm. Soak time of 15 minutes and wash time of 30 minutes at 28° C. was used. The rinsing was done in soft water at L/C ratio of 40:1. Swatches are dried using a maxi drier. Fabric reflectance (initial/final) measurements are made using a Color-Eye Macbeth Reflectometer (using UV Excluded, Specular Included and Large Aperture View mode) and difference in reflectance dR(460*) was calculated.

TABLE 3

| Components | | | |
|---|---|---|---|
| % wt. | Ex. 11 | Ex. 12 | Ex. 13 |
| Surfactant, wt % | 10 | 100 | Commercial Surf |
| | AOT | AOT | Excel Liquid |
| | (HLB = | (HLB = | formulation |
| | 10-14.9) | 10-14.9) | |
| Hydrophobic liquid, | 80 | — | — |
| Octane, wt % | | | |
| (Log P = 4.7) | | | |
| Solubility = 7 × 10⁻⁵% | | | |
| Water | 10 | — | — |
| dR(460*) (WFK20D) | 17 | 5 | 9 |

AOT denotes Aerosol OT.
*The HLB of AOT is indicated to be a range as per the article of David A. Sabatini., Robert C. Knox and Jeffrey H. Harwell - Environmental Research Brief - Surfactant-Enhanced DNAPL Remediation: Surfactant Selection, Hydraulic Efficiency, and Economic Factors - August 1996.

It is also referenced in B. J. Shiau, David A. Sabatini and Jeffery H. Harwell., “Solubilization and Microemulsification of Chlorinated Solvents Using Direct Food Additive (Edible) Surfactants,” Ground Water. 32(4), 1994, 561-569.

The data in Table-3 indicates that cleaning in the direct application mode using a formulation as per the invention (Ex-11) provides for vastly improved cleaning over the surfactant alone and over a commercial liquid detergent formulation.

Detergency Results by Washing in Saline Water:

The procedure employed in these set of experiments were the same as used in the “bulk wash mode” described above. In these set of experiments a microemulsion formulation as given in Table 4-A below was prepared:

TABLE 4A

| S. No | Ingredient | Wt % |
|---|---|---|
| 1 | LLPO | 37.5 |
| 2 | Caprylic Acid | 3.8 |
| 3 | C₁₂EO₃ | 1.6 |
| 4 | C₁₂EO₇ | 14.1 |
| 5 | Water | 38.3 |
| 6 | Salt (NaCl) | 7.7 |

Several wash liquors as listed in Table-4B below were prepared and test monitors WFK10D and WFK20D washed in these liquors were measured for detergency improvement.

TABLE 4B

| | | dR(460*), | dR(460*), |
|---|---|---|---|
| Example | Wash Liquor Emulsion | WFK 20D | WFK 10D |
| Ex-14 | Formulation as per Table-4A diluted | 5 | 5 |
| | in zero FH water at active levels of | | |
| | 1.5 gram/liter | | |
| Ex-15 | Formulation as per Table-4A diluted | 27 | 20 |
| | in brine (15%) with active levels of | | |
| | 1.5 gram/liter | | |
| Ex-16 | Surfactants (C₁₂₋₁₄ EO₃:C₁₂₋₁₄EO₇) | 16 | 11 |
| | at 1:9 diluted in zero FH water at | | |
| | 1.5 grams/liter | | |
| Ex-17 | Surfactants (C₁₂₋₁₄ EO₃:C₁₂₋₁₄EO₇) | 14 | 12 |
| | at 1:9 diluted in brine (15%) with | | |
| | active levels of 1.5 grams/liter | | |
| Ex-18 | 15% brine | 2 | 2 |

The data in Table-4B indicates that there is synergistic benefit in washing the test monitors in an emulsion formed by diluting the microemulsion formulation as per the invention with brine (Ex-15) as opposed to dilution with water (Ex-14) and washing in brine (Ex-18). This synergy is not observed in a parallel set of experiments with surfactant diluted in water (Ex-16) and surfactant diluted in brine (Ex-17).

Detergency Results by Washing in Hard Water in the Absence of Builders:

Microemulsion formulation as per Table-4A was taken and the procedure as per the experiments in the ‘washing in saline water’ was used to determine detergency in test monitors WFK10D and WFK20D. The only difference was that the samples were diluted with 6% brine solution to achieve an active level of 1.5 g/liter (Ex-19) and with 6% brine solution containing calcium chloride to achieve a hardness of 48FH and an active level of 1.5 g/liter (Ex-20). The results of the detergency obtained are given in the Table-5 below.

TABLE 5

| | | dR(460*), | dR(460*), |
|---|---|---|---|
| Example | Wash Liquor Emulsion | WFK 20D | WFK 10D |
| Ex-19 | Formulation as per Table-4A diluted | 21 | 14 |
| | in 6% brine solution at active | | |
| | levels of 1.5 gram/liter | | |
| Ex-20 | Formulation as per Table-4A diluted | 19 | 13 |
| | in 6% brine containing calcium | | |
| | carbonate to get a 48 FH water | | |
| | with active levels of 1.5 | | |
| | gram/liter | | |

The data in Table-5 above indicates that improved cleaning on par with soft water is obtained when cleaning test monitors using the microemulsion of the invention diluted in hard water in the absence of builders (Ex-20).

Results of Flourescer Delivery

Experiments were conducted using the procedure as per the ‘bulk wash’ mode described above. Microemulsion composition was prepared as per Table-6 where the flourescer content was kept same as that of commercial liquid detergent Surf Excel. The wash liquor was prepared by diluting with 0 FH water such that the active level was at 1.5 g/liter. The F value was calculated as R₄₆₀−R_{460*} where R460 is the reflectance value obtained with UV included, specular included and large aperture view mode and R460* is the reflectance value obtained with UV excluded, specular included and large aperture view mode. Several test monitors e.g WFK10D, WFK20D, WFK30D and terrace test monitors were washed and the results are shown in Table-7.

TABLE 6

| Formulation ingredient | Wt % |
|---|---|
| NaLAS | 25.7 |
| (2-Ethyl Hexanol EO_{<3>}) | 25.7 |
| LLPO | 21.4 |
| Water | 17.5 |
| Salt | 1.0 |
| Tinopal CBSX | 0.1 |
| (Mono Ethanol Amine) | 8.6 |

TABLE 7

| Example | | F | F | F | F |
|---|---|---|---|---|---|
| No. | Formulation | WFK10D | WFK20D | WfK30D | Terrace |
| Ex-21 | Microemulsion | 7 | 5 | 1 | 6 |
| | as per Table-6 | | | | |
| Ex-22 | Surf Excel | 3 | 2 | 1 | 5 |

The data in Table-7 above indicates that the fluorescer delivery using the microemulsion as per the invention provides on-par to superior benefits over the best commercial detergent formulation.

Comparison of Results using Microemulsion Route (Spontaneous Emulsification) with that of “Artificially Created Emulsion”

A microemulsion as per Table-8 was prepared. The microemulsion was diluted with 15% brine solution to prepare a bulk wash liquor with the active (surfactant) level at 1.5 g/liter. The bulk wash liquor had a clear transparent appearance and the droplet size was measured to be in the range of 35 to 500 nanometers. The droplet size was determined using Dynamic Light Scattering Techniques.

In comparison an artificially created emulsion was prepared by mechanically mixing all the ingredients in Table-8 with the same amount of brine to obtain a wash liquor which was turbid.

Test monitors WFK10D and WFK20D were washed in these two wash liquors using the same procedure as in the ‘bulk wash’ experiments and the results are summarized in Table-9.

TABLE 8

| Ingredient | Wt. % |
|---|---|
| LLPO | 22.6 |
| 2-Ethyl hexanol | 22.6 |
| (EO)_{<3>} | |
| NaLAS | 28.6 |
| Water | 24.5 |
| Salt (NaCl) | 1.9 |

TABLE 9

| | | dR | dR |
|---|---|---|---|
| Example | | (460*) | (460*) |
| No. | Formulation | WFK10D | WFK20D |
| Ex-23 | “Spontaneously formed” emulsion | 22 | 26 |
| | via Microemulsion route | | |
| Ex-24 | “Artificially created emulsion” | 18 | 22 |

The data in Table-9 indicates that there is considerable improvement in detergency when the microemulsion route is chosen as opposed to mixing the ingredients in the wash liquor in an artificially created emulsion.

It is thus possible by way of the invention to obtain microemulsion compositions for superior cleaning of fabric and hard surfaces by using microemulsion compositions that form spontaneous kinetically stable dispersion of hydrophobic liquid in water, saline water, hard water with out use of builders and can also be used for delivery of benefit agents.

1. A cleaning composition in the form of a microemulsion comprising:
(a) 5-95% by weight a surfactant with a HLB greater than
(b) 0.1-95% by weight of one or more hydrophobic liquids having a net log p value greater than 3.0 and a water solubility less than 0.1% and
(c) 0.05-95% by weight water.

2. A cleaning composition according to claim 1, wherein at least 5% of the hydrophobic liquid has a log p value less than 4.3 and a water solubility less than 0.1%.

3. A cleaning composition according to claim 1, wherein at least 5% of the hydrophobic liquid has a log p value less than 4.3 and a water solubility less than 0.01%.

4. A cleaning composition according to claim 1 wherein at least 5% of the hydrophobic liquid has a log p value less than 4.3 and a water solubility less than 0.001%.

5. A cleaning composition according to claim 1 wherein the composition additionally comprises 0.5 to 30% by weight of a salting out electrolyte.

6. A cleaning composition according to claim 1, wherein the composition comprises 0.5 to 15% by weight of the salting out electrolyte.

7. A cleaning composition according to claim 1, wherein the composition comprises 0.5 to 6% by weight of the salting out electrolyte.

8. A cleaning composition according to claim 1, wherein the composition is in liquid form.

9. A cleaning composition according to claim 1, wherein the composition is free of builders.

10. A cleaning composition according to claim 1, wherein the composition additionally comprises one or more conventional benefit agents.

11. A cleaning composition according to claim 10, wherein the conventional benefit agent is chosen from one or more of fluorescer, sunscreen, anti-yellowing agent or whiteness-maintaining agent.

12. A method of cleaning soiled substrate comprising the steps of
(a) cleaning the substrate with a composition according to claim 1 and
(b) rinsing the substrate.

13. A method of cleaning soiled substrate according to claim 12 wherein the substrate to be cleaned is brought in contact with a solution prepared by diluting the composition according to claim 1 in soft, hard or saline water.

14. A method of cleaning soiled substrate according to claim 12, wherein the hydrophobic liquid in the solution is in the range of 0.01 to 1.5% by weight of the solution.
